(19) United States
(12) Patent Application Publication
(10) Pub. No.: US 2006/0179461 A1
(43) Pub. Date: Aug. 10, 2006

(54) Movies on demand (MOD)

(76) Inventor: Jai Jenell Horne Marz, Ventura, CA (US)

Correspondence Address: Jai Jenell Marz, 1415 Zion Way, Ventura, CA, 93003, US

(21) Appl. No.: 11/052,728

(22) Filed: Feb. 7, 2005

(51) Int. Cl. H04N 5/445; G06F 13/00; H04N 7/173; G06F 3/00

(52) U.S. Cl. 725/87; 725/61; 725/52; 725/53; 725/86

(57) ABSTRACT

A process of providing residents who subscribe to, Movies on Demand, access from there homes. Using a satellite, Internet and\or cable feed. By using these links you will be able to view all movies, via a broadband feed or a satellite feed and\or digital feed including cable and Internet. The receiver combined with the Digital Video Recorder (DVR) then translates all these to the television in residents home to receive movie/s chosen.

### REFERENCES CITED

U.S. Patent Documents

| | | | |
|---|---|---|---|
| 4972479 | November, 1990 | Tobia, Jr, et al | 380\33 |
| 5392354 | February, 1995 | Takahashi et al | 380\23 |
| 6557030 | May, 2000 | Hoang; Khoi | 790\217 |
| 6477579 | November, 2002 | Kunkel et al. | |
| 6377690 | April, 2002 | Witschorik | 380\268 |
| 6456824 | September, 2002 | Butte et al | 455\12. |

### OTHER REFERENCES

Dosch ch., EBU Technical Review, Digital broadcasting of studio-quality HDTV by satellite in the 21-GHZ frequency range and by coaxial cable networks, summer 1993, pp. 47-53.*

Video on demand Technologies and demonstrations, f\Final Report, Marek Podgorny and Geoffrey C. Fox, Norhteast Parallel Architectures Center, Contract No.: F-30602-94-C-

### BACKGROUND OF INVENTION

### Field of Invention

Problem:

Movies on Demand (MOD) are related to PPV (pay per view), DVR (digital video Recorder) and any movie rentals. With these products you would be able to watch your Favorite shows as well as record them and fast forward rewind, and pause at your leisure. The problem with these is the fact that you cannot watch the movies that you would want To at any moment day or night. You would not be able to look up your favorite movie From any time period, be it by title or director and/or year of release, and bring it up on Your television. All of the local and PPV channels have the movies as to which the cable Or Satellite Company has programmed in. But not the ones you may wish to see at that Time. You would still have to pay the monthly fees even if you do not watch any movies. With MOD you will not need to go out of your home to a video store to see a movie that is not in stock, or wait for a Pay-Per-View movie to start.

### BRIEF SUMMERY OF THE INVENTION

Solution:

Using Movies on Demand (MOD) can solve these problems. This is something that is advanced over the products listed because you will no longer have to leave your home or worry about it skipping or returning and having a late fee. All you will need is the receiver with Internet access and/or cable access and/or satellite to down load your favorite movie/s. You will be sitting in front of your television and be able to watch the movie/s you want to see at that time. You will be able to pause, rewind, fast forward, and stop your movie when you choose to, similar to a DVR. You will get the most current movies and up to date movies your favorite movie rental agent may have. You will never have a line or have to be in the rain to get your movie. It will be open 24 hours a day 365 days a year. You would pay the price of the receiver and/or remote and/or the cost of each movie you see. Your movie would be downloaded to your receiver and be there for a specified amount of time and/or a specified number of movies in the digital video recorder. Then it would be deleted from your Movies On Demand (MOD) or be replaced by newly ordered movies.

### DETAILED DESCRIPTION OF THE INVENTION

The Movies on Demand (MOD) would be a system that uses a cue of sorts that would hold all of the movies that the agent or agencies i.e. Blockbuster, Hollywood Video any movie rental agent would have. Also it would have a receiver with cables for audio and visual to go directly to your television and or sound system; there would also be a power button and power cables. The MOD box would also come with a remote; using telephone and\or Internet access line and/or satellite and/or cable; using these options you would be able to type the name of the movie and/or the director and/or year of your movie. The receiver would linkup to the satellite server and/or cable and/or Internet server i.e. which ever the agent is using so that the client may gain access to the movie of their choosing. in order to bring your movie in to where you are located. Movie/s will be able to be seen using this device. You can do all of this by plugging the equipment in, turning on the system and then by choosing the name and/or director and/or year of the movie you wish to see. Then on your screen you will see the movies that have come up with the description you have inputted. All you need to do is choose the movie you wish to see and the movie will begin. Using the digital video recorder technology is needed to use the features of; rewind and pause, fast forward and to stop the downloaded movie.

### ABSTRACT OF THE DISCLOSURE

The Movies On Demand (MOD) is a receiver using some of the Digital recorder Technology and/or Tivo, which you can use for ordering movies. You will be able to see all movie/s that have been released by keying in the movie title and/or the directors name and/or the year of release via access though your television/internet/telephone access. It will then be brought up on your television screen and you will then be able to watch the movie\s of your choosing without leaving your home. This is just like renting a movie from any movie rental agent. This is the first of its kind to be able to download movies by title and/or directors name, or year released straight to your television. Providing you with the ability to watch the movie at your leisure beginning the movie when you choose, pausing, stopping, rewinding, fast forwarding, the movie all without leaving your home to rent a, DVD and\or VHS video\and\or lazar disk that must be returned to the rental agent.

What is claimed is:

1). A method of sending any and all movie/s ever made at any time to your home via satellite and/or cable and/or internet, the method comprising on:
(a) To receiving your downloaded movie that you have chosen by
(b) Typing in the directors name
(c) By inputting in the movie title and/or year
(d) Arrow to the movie select you wish to see using your remote control, telephone, or internet access.

2). Following the method of claim 1,
(a) The signal will initiate a download of the requested movie/s via satellite and/or cable and/or internet access. Whichever the agent has choosen to use
(b) Then upon the signal being received the movie will download via satellite and/or cable and/or Internet to an in home digital video recorder.
